(19) United States
(12) Patent Application Publication
(10) Pub. No.: US 2006/0081006 A1
(43) Pub. Date: Apr. 20, 2006

(54) Methods for manufacturing glass and for manufacturing thin film transistor liquid crystal display with lower glass sag

(75) Inventor: Hsiao Chian Chih, Taipei County (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: HannStar Display Corp., Tao-Yuan Hsien (TW)

(21) Appl. No.: 11/066,939

(22) Filed: Feb. 25, 2005

(30) Foreign Application Priority Data
Oct. 15, 2004 (TW) 093131462

(51) Int. Cl. C03C 19/00

(52) U.S. Cl. 65/61; 65/60.2

(57) ABSTRACT

Methods for manufacturing the glass substrate and for manufacturing the thin film transistor with lower glass sag are provided. The glass sag can be reduced by depositing a dielectric layer on the upper surface or the lower surface of the glass substrate and adjusting the stress applied thereon. This technology can be integrated not only into the manufacturing process for glass substrates but into that for thin film transistors.

### FIELD OF THE INVENTION

The present invention relates to methods for manufacturing the glass substrate and for manufacturing the thin film transistor liquid crystal display, and more particularly to methods for manufacturing the glass substrate and for manufacturing the thin film transistor liquid crystal display with lower glass sag.

### BACKGROUND OF THE INVENTION

In the process for manufacturing the semiconductor, the bare glass 11 is supported by side bars 12, as shown in FIG. 1. This way will cause sag of the glass. If the thickness of the bare glass 11 employed gets thinner, e.g. from 0.7 mm to 0.5 mm, or the size thereof gets larger, e.g. from 550×650 mm for the third generation standard to 1200×1300 mm for the fifth generation standard, the sag of the glass will be even larger. This will damage the bare glass 11 while being conveyed, and thus it is not easy to produce lightweight products.

Please refer to Table 1, which is a comparison sheet of the sags for three kinds of bare glass with different thickness provided by Corning Corp. As shown in Table 1, the thinner the bare glass is, the larger the sag thereof will be. Therefore, it is not easy to utilize the thin bare glass for the lightweight product fabrication.

TABLE 1

| Glass | Thickness | Density | Width size of bare glass (mm) | | | |
|---|---|---|---|---|---|---|
| type | (mm) | (g/cm³) | 550 | 610 | 680 | 730 |
| NA35 | 0.7 | 2.49 | 9.2 | 14.2 | 22.2 | 29.7 |
| E-2000 | | 2.37 | 8.5 | 13.1 | 20.5 | 27.4 |
| 1737 | | 2.54 | 9.0 | 13.8 | 21.7 | 29.0 |
| NA35 | 0.63 | 2.49 | 11.4 | 17.5 | 27.4 | 36.7 |
| E-2000 | | 2.37 | 10.5 | 16.1 | 25.3 | 33.8 |
| 1737 | | 2.54 | 11.1 | 17.1 | 26.8 | 35.8 |
| NA35 | 0.5 | 2.49 | 18.1 | 26.0 | 43.5 | 58.2 |
| E-2000 | | 2.37 | 16.7 | 24.0 | 40.1 | 53.7 |
| 1737 | | 2.54 | 17.7 | 25.5 | 42.5 | 56.9 |

From the above description, it is known that how to develop a method for reducing the glass sag so as to easily produce lightweight products has become a major problem waited to be solved. In order to overcome the drawbacks in the prior art, methods for manufacturing the glass substrate and for manufacturing the thin film transistor with lower glass sag are provided. The particular design in the present invention not only solves the problems described above, but also is easy to be implemented. Thus, the invention has the utility for the industry.

### SUMMARY OF THE INVENTION

In accordance with one aspect of the present invention, methods for manufacturing the glass substrate and for manufacturing the thin film transistor with lower glass sag are provided. The glass sag can be reduced by depositing a dielectric layer on the upper surface or the lower surface of the glass substrate and by adjusting the stress applied thereon. This technology can be integrated not only into the manufacturing process for glass substrates but into that for thin film transistors.

In accordance with another aspect of the present invention, a method for manufacturing a glass substrate is provided. The method includes steps of (a) providing a liquid glass matrix, (b) solidifying the liquid glass matrix to form a glass matrix, (c) dividing the glass matrix into a plurality of glass units, (d) polishing each glass unit, (e) cutting a plurality of angled portions of each glass unit, (f) washing each glass unit, and (g) forming a dielectric layer on a surface of each glass unit to form the glass substrate, wherein the dielectric layer is formed with a radio frequency ranged from 10 kHz to 100 MHz and a power density ranged from 0 to 1.4 Watts/cm², and applies a stress on each glass unit.

Preferably, the dielectric layer is made of one selected from a group consisting of SiOx, SiNx, SiOxNy and mixture thereof.

Preferably, the dielectric layer has a thickness ranged from 500 Å to 5000 Å.

Preferably, the surface of each glass unit is an upper surface thereof and the stress is a compressive stress.

Preferably, the compressive stress is ranged from −1×10⁹ dyne/cm² to −20×10⁹ dyne/cm².

Preferably, the surface of each glass unit is a lower surface thereof and the stress is a tensile stress.

Preferably, the tensile stress is ranged from 1×10⁹ dyne/cm² to 20×10⁹ dyne/cm².

Preferably, the dielectric layer is formed under a pressure ranged from 0 to 10 Torr.

Preferably, the dielectric layer is formed at a temperature ranged from 25° C. to 400° C.

Preferably, the glass substrate has sag controlled between 0 to 14 mm.

In accordance with a further aspect of the present invention, a method for manufacturing a liquid crystal display is provided. The method includes steps of (a) providing a glass unit, (b) forming a dielectric layer on a surface of the glass unit to form a glass substrate, wherein the dielectric layer is formed with a radio frequency ranged from 10 kHz to 100 MHz and a power density ranged from 0 to 1.4 Watts/cm², and applies a stress on the glass unit, and (c) forming a thin film transistor structure on the dielectric layer.

Preferably, the dielectric layer is made of one selected from a group consisting of SiOx, SiNx, SiOxNy and mixture thereof.

Preferably, the dielectric layer has a thickness ranged from 500 Å to 5000 Å.

Preferably, the surface of each glass unit is an upper surface thereof and the stress is a compressive stress.

Preferably, the compressive stress is ranged from −1×10⁹ dyne/cm² to −20×10⁹ dyne/cm².

Preferably, the surface of each glass unit is a lower surface thereof and the stress is a tensile stress.

Preferably, the tensile stress is ranged from 1×10⁹ dyne/cm² to 20×10⁹ dyne/cm².

Preferably, the dielectric layer is formed under a pressure ranged from 0 to 10 Torr.

Preferably, the dielectric layer is formed at a temperature ranged from 25° C. to 400° C.

Preferably, the glass substrate has sag controlled between 0 to 14 mm.

Preferably, the thin film transistor structure is a back channel etched thin film transistor.

Preferably, the back channel etched thin film transistor is formed by steps of (a′) forming a gate structure, a storage capacitor and a contact pad on the glass substrate, (b′) forming a gate insulating layer on the gate structure, the storage capacitor and the contact pad, (c′) sequentially forming a channel layer and a semiconductor layer on the gate insulating layer corresponding to the gate structure, (d′) forming a source/drain layer on the semiconductor layer, (e′) etching the source/drain layer, the semiconductor layer and the channel layer to form a first opening located on the channel layer, (f′) forming a protective layer on the source/drain layer and the gate insulating layer, and etching the protective layer to form a contact hole located on the source/drain layer and a second opening located on the contact hole, and (g′) forming a transparent pixel electrode region on the contact hole, the protective layer corresponding to the storage capacitor and the second opening.

Preferably, the gate insulating layer is made of one selected from a group consisting of SiOₓ, SiNₓ, SiOₓN_{y}, TaOₓ, AlOₓ and mixture thereof.

Preferably, the source/drain layer is made of a metal with a low resistance.

Preferably, the metal is one selected from a group consisting of Mo, Al, AlNd alloy, Cr and mixture thereof.

Preferably, the thin film transistor structure is an etching stopper thin film transistor structure.

Preferably, the etching stopper thin film transistor structure is formed by steps of (a″) forming a gate structure, a storage capacitor and a contact pad on the glass substrate, (b″) sequentially forming a gate insulating layer and a channel layer on the gate structure, the storage capacitor and the contact pad, (c″) forming an etching stopper structure on the channel layer corresponding to the gate structure, (d″) sequentially forming a semiconductor layer and a source/drain layer on the etching stopper structure and the channel layer, and etching the semiconductor layer and the source/drain layer to form a first opening located on the etching stopper structure, (e″) removing the channel layer, the semiconductor layer and the source/drain layer which are corresponding to the contact pad, (f″) forming a protective layer on the source/drain layer and the gate insulating layer, and etching the protective layer to form a contact hole located on the source/drain layer and a second opening located on the contact pad, and (g″) forming a transparent pixel electrode region on the contact hole, the protective layer corresponding to the storage capacitor and the second opening.

Preferably, the gate insulating layer is made of one selected from a group consisting of SiOₓ, SiNₓ, SiOₓN_{y}, TaOₓ, AlOₓ and mixture thereof.

Preferably, the source/drain layer is made of a metal with a low resistance.

Preferably, the metal is one selected from a group consisting of Mo, Al, AlNd alloy, Cr and mixture thereof.

The above objects and advantages of the present invention will become more readily apparent to those ordinarily skilled in the art after reviewing the following detailed descriptions and accompanying drawings, in which:

### DESCRIPTION OF THE DRAWINGS

FIG. 1 shows how the side bars support the bare glass.

FIG. 2(a) shows the dielectric layer formed on the surface of the glass substrate by applying the compressive stress.

FIG. 2(b) shows the dielectric layer formed on the surface of the glass substrate by applying the tensile stress.

FIG. 3 shows the relationship between the radio frequency power and the applied stress while the dielectric layer is formed on the surface of the glass substrate.

FIG. 4 shows the positions of the measuring points after forming the dielectric layer on the surface of the glass substrate.

FIGS. 5(a)˜5(b) show the process for manufacturing the glass substrate according to a preferred embodiment of the present invention.

FIGS. 6(a)˜6(e) show the process for manufacturing the back channel etched thin film transistor according to a preferred embodiment of the present invention.

FIGS. 7(a)˜7(e) show the process for manufacturing the etching stopper thin film transistor according to a preferred embodiment of the present invention.

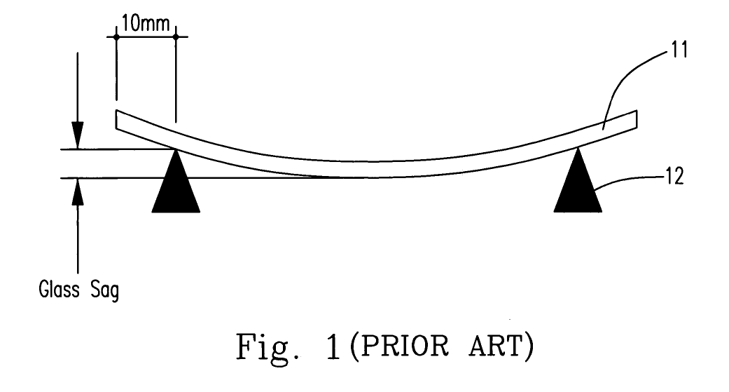

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

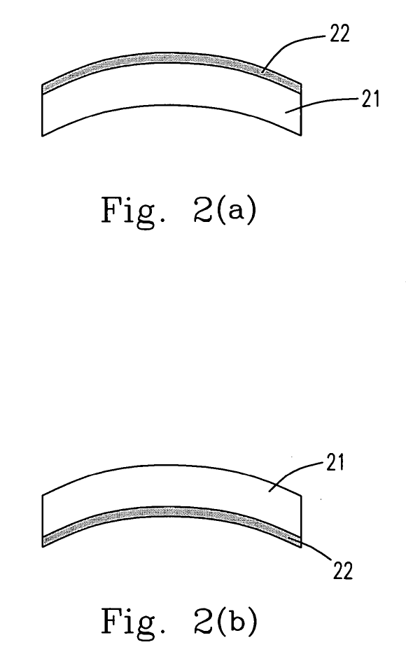

In order to reduce the sag of the glass substrate, a practical method is proposed by the present invention to achieve the above object. Please refer to FIG. 2(a), which shows the dielectric layer formed on the surface of the glass substrate by applying the compressive stress. As shown in FIG. 2(a), a dielectric layer 22 is formed on the upper surface of the glass substrate 21 with a compressive stress applied thereon. For example, the dielectric layer 22 is a SiOₓ layer or a SiNₓ layer, and has a thickness approximately ranged from 500 Å to 5000 Å. In addition, the dielectric layer 22 is formed on the glass substrate 21 by the plasma enhanced chemical vapor deposition (PECVD). The operation conditions are as follows:
Radio frequency: 10 kHz to 100 MHz
Power density: 0 to 1.4 Watts/cm²
Compressive stress: −1×10⁹ dyne/cm² to −20×10⁹ dyne/cm²
Pressure: 0 to 10 Torr
Temperature: 25° C. to 400° C.

Besides the application of the compressive stress, the dielectric layer 22 can also be formed on the lower surface of the glass substrate 21 with a tensile stress applied thereon, as shown in FIG. 2(b). In this case, all the operation conditions are the same as those with the application of the compressive stress, except that the tensile stress is ranged from 1×10⁹ dyne/cm² to 20×10⁹ dyne/cm². Moreover, the sag of the glass substrate 21 is controlled between 0 to 14 mm so as to achieve the optimal effect.

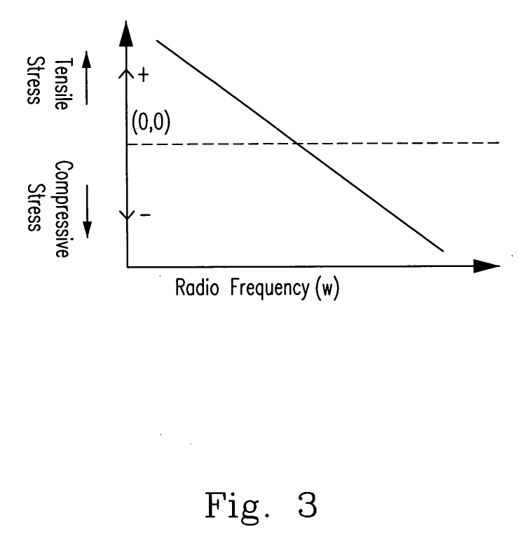

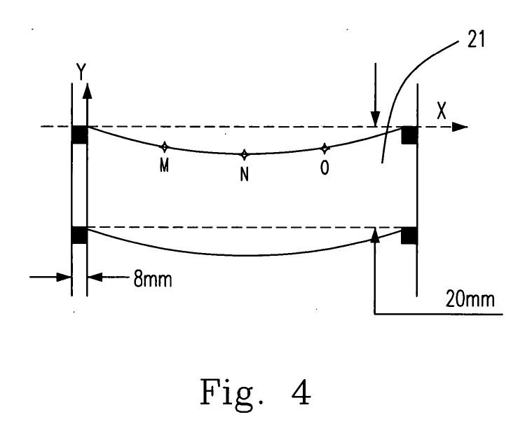

Please refer to FIG. 3, which shows the relationship between the radio frequency power and the applied stress while the dielectric layer 22 is formed on the surface of the glass substrate 21. As shown in FIG. 3, the smaller the compressive stress is, the larger the radio frequency will be. By contrast, the larger the tensile stress is, the smaller the radio frequency will be.

The theorem adopted in the reduction of the glass sag is illustrated in the following equation.

$$w = \frac{5}{32} \frac{{l}^{4} gρ ( 1 - {v}^{2} )}{{Et}^{2}}$$

In which, w is the glass sag, E is Young's modulus, ρ is the density, l is the unsupported length, t is the thickness, and v is Poisson's ratio

$$( v = - \frac{{ɛ}_{lat}}{{ɛ}_{long}} ) .$$

ε_{long} is the deformation in the force-bearing direction and εₗₐₜ is the deformation in the non force-bearing direction. The stress σ_{DielectricLayer} will be applied on the glass substrate 21 through the dielectric layer 22. Based on the mechanics principle, the strain resulted from the applied stress is able to counteract the glass sag caused by parts of gravity (g), and thus the glass sag (w) can be reduced.

Please refer to FIG. 4, which shows the positions of the sag measuring points after forming the dielectric layer (not shown) on the surface of the glass substrate 21. As shown in FIG. 4, there are three measuring points M, N and O on the glass substrate 21 after forming the dielectric layer thereon. M is located on the position which is 150 mm away from the left side of the glass substrate 21, N is located on the center of the glass substrate 21, and O is located on the position which is 150 mm away from the right side of the glass substrate 21. The measurement is exemplified by forming a SiNx layer of 2000 Å on the glass substrate 21 of Corning 1737 (0.7 mm) and the glass substrate 21 of Corning E2000 (0.5 mm) respectively. The measuring results are shown in Tables 2 and 3 respectively.

TABLE 2

| | Sag on M | Sag on N | Sat on O | |
|---|---|---|---|---|
| | (mm) | (mm) | (mm) | Film Stress (dyne/cm²) |
| 1737 | 5.98 | 8.25 | 5.98 | 0 |
| 1737 SiNx | 5.81 | 8.04 | 5.81 | −1.0 × 10⁹ |
| | 5.44 | 7.52 | 5.44 | −5.0 × 10⁹ |
| | 5.16 | 7.13 | 5.16 | −8.0 × 10⁹ |
| | 4.97 | 6.87 | 4.97 | −10.0 × 10⁹ |
| | 4.50 | 6.21 | 4.50 | −15.0 × 10⁹ |
| | 4.06 | 5.61 | 4.06 | −20.0 × 10⁹ |

TABLE 3

| | Sag on M | Sag on N | Sag on O | |
|---|---|---|---|---|
| | (mm) | (mm) | (mm) | Film Stress (dyne/cm²) |
| E-2000 | 5.44 | 14.04 | 5.44 | 0 |
| E-2000 SiNx | 5.16 | 13.79 | 5.16 | −1.0 × 10⁹ |
| | 4.97 | 12.79 | 4.97 | −5.0 × 10⁹ |
| | 4.50 | 12.04 | 4.50 | −8.0 × 10⁹ |
| | 4.07 | 11.54 | 4.07 | −10.0 × 10⁹ |
| | 5.44 | 11.28 | 5.44 | −15.0 × 10⁹ |
| | 5.16 | 8.97 | 5.16 | −20.0 × 10⁹ |

As shown in Tables 2 and 3, in both examples (Corning 1737 and Corning E2000), the glass sags respectively measured on the measuring points M, N and O are reduced as the film stress (compressive stress) changes. Compared to the glass substrate 21 without the compressive stress applied thereon, the glass substrate 21 with the compressive stress applied thereon apparently has lower sag.

The above method for reducing the sag of the glass substrate can be applied to both of the glass substrate and the thin film transistor fabrications. The processes for manufacturing the glass substrate and for manufacturing the thin film transistor by using the above method will be illustrated as follows.

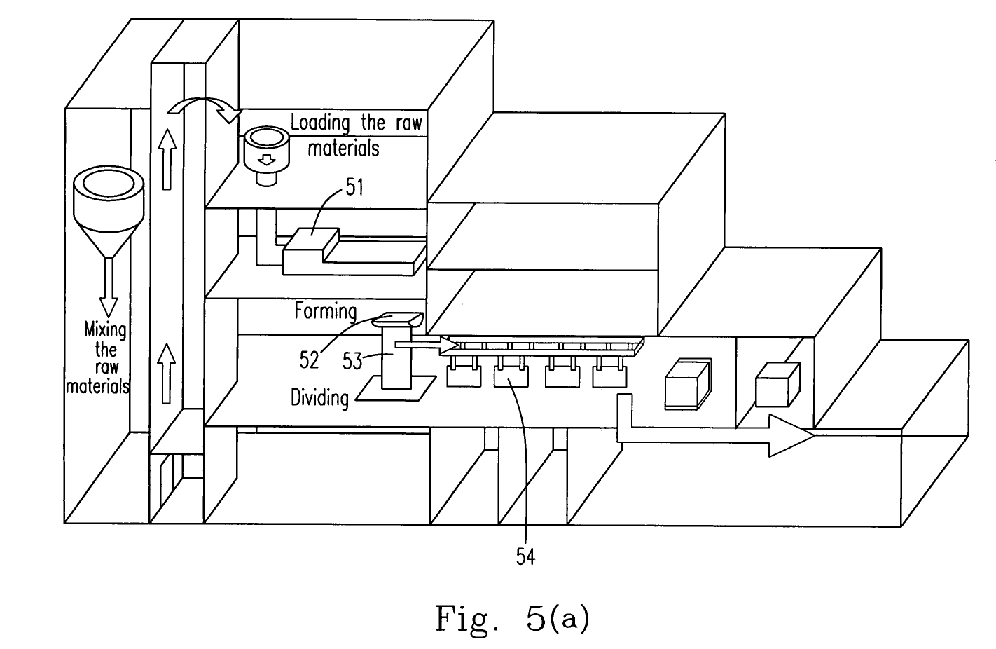

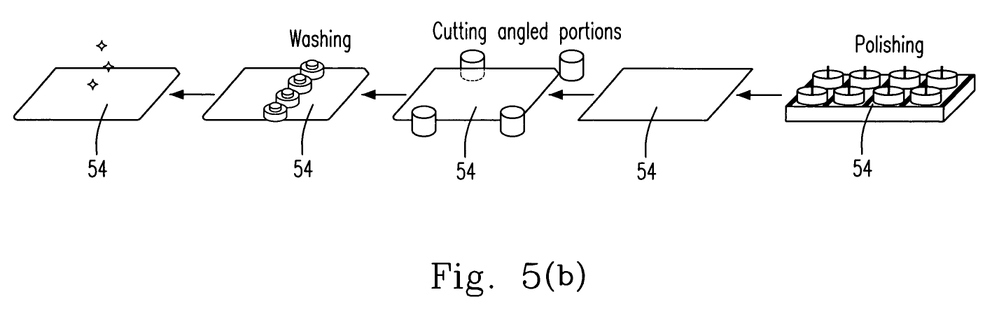

Please refer to FIGS. 5(a)˜5(b), which show the process for manufacturing the glass substrate according to a preferred embodiment of the present invention. At first, a plurality of raw materials are prepared and then mixed. Next, the raw materials are melted and refined by a melting furnace 51 to form a liquid glass matrix 52. Afterwards, the liquid glass matrix 52 is solidified to form a glass matrix 53. Then, the glass matrix 53 is divided into a plurality of glass units 54, as shown in FIG. 5(a). After that, each glass unit 54 is polished, four angled portions of each glass unit 54 are cut, and each glass unit 54 is washed. Finally, a dielectric layer (not shown) is formed on a surface of each glass unit 54 to form a glass substrate (not shown), wherein a stress is applied on the glass unit 54 through the dielectric layer, and such a manufacturing process is similar to the above manufacturing process for reducing the sag of the glass substrate. That is, the dielectric layer is formed on the upper surface of each glass unit 54 so that the compressive stress ranged from −1×10⁹ dyne/cm² to −20×10⁹ dyne/cm² is applied thereon, or the dielectric layer is formed on the lower surface of each glass unit 54 so that the tensile stress ranged from 1×10⁹ dyne/cm² to 20×10⁹ dyne/cm² is applied thereon. The dielectric layer is formed on each glass unit 54 by the plasma enhanced chemical vapor deposition. Besides, the operation conditions are all the same as those in the above manufacturing process for reducing the glass sag. That is:
Radio frequency: 10 kHz to 100 MHz
Power density: 0 to 1.4 Watts/cm²
Compressive stress: −1×10⁹ dyne/cm² to −20×10⁹ dyne/cm²
Pressure: 0 to 10 Torr
Temperature: 25° C. to 400° C.

Furthermore, the sag of each glass substrate is controlled between 0 to 14 mm so as to achieve the optimal effect.

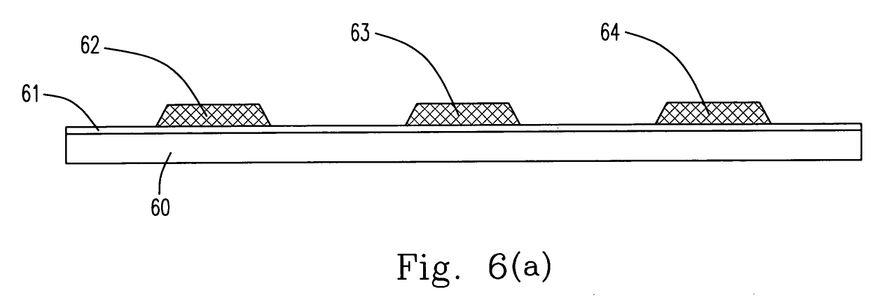

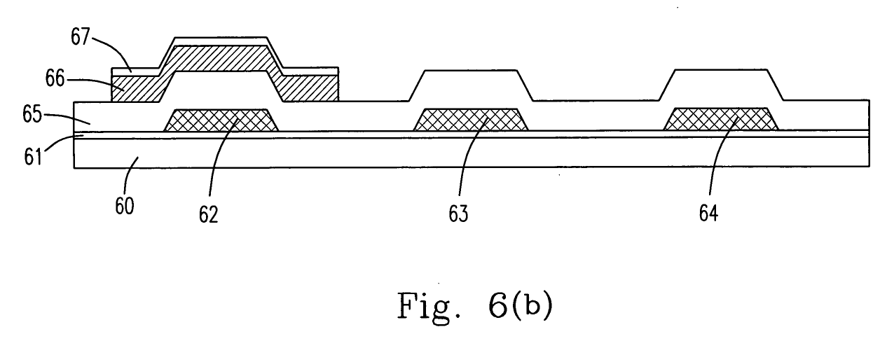

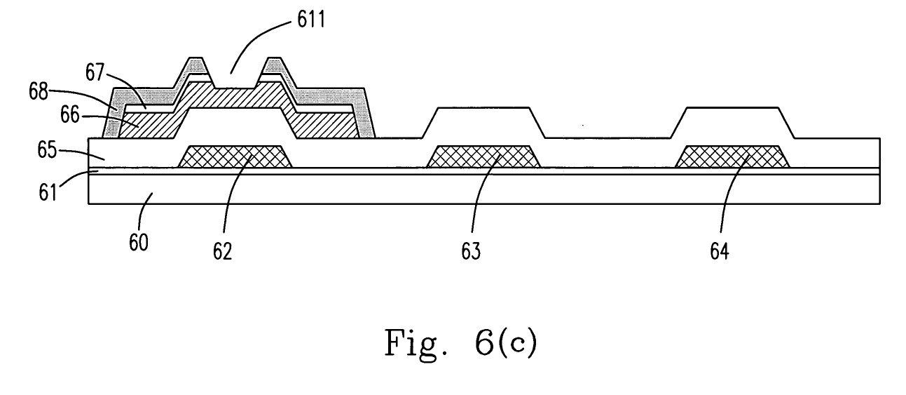

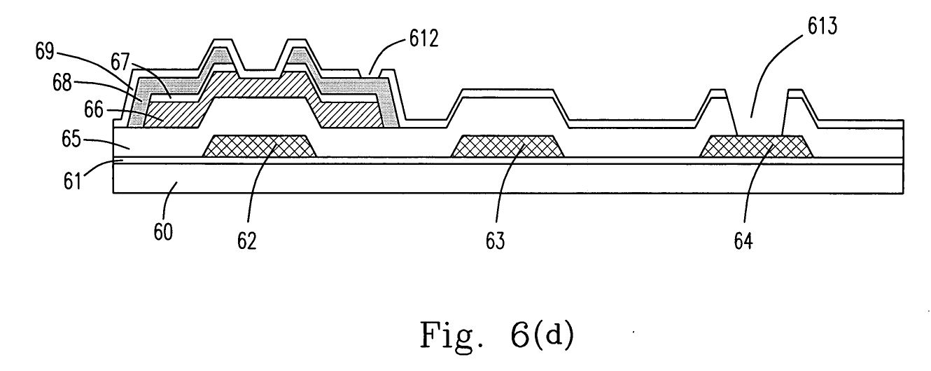

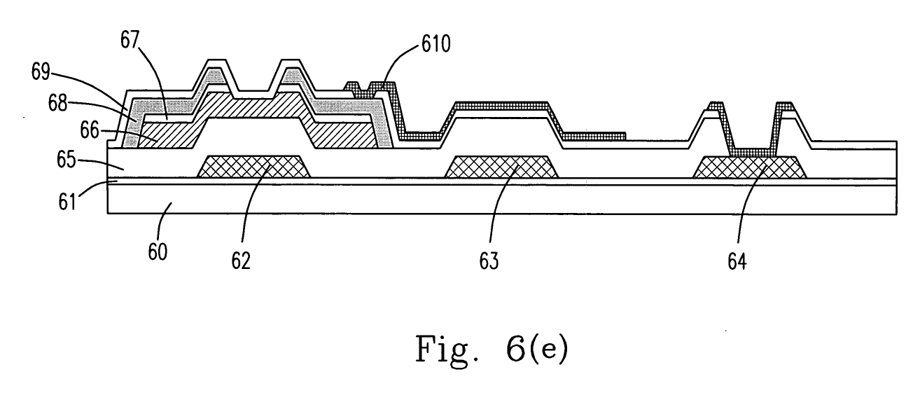

Please refer to FIGS. 6(a)˜6(e), which show the process for manufacturing the back channel etched thin film transistor according to a preferred embodiment of the present invention. At first, a dielectric layer 61 is formed on an upper surface of the glass substrate 60 by employing the above manufacturing process for reducing the glass sag. Then, a gate structure 62, a storage capacitor 63 and a contact pad 64 are formed on the glass substrate 60, and then a gate insulating layer 65 is formed on the gate structure 62, the storage capacitor 63 and the contact pad 64. Afterwards, a channel layer 66 and a semiconductor layer 67 are sequentially formed on the gate insulating layer 65 corresponding to the gate structure 62, and then a source/drain layer 68 is formed on the semiconductor layer 67. Next, the source/drain layer 68, the semiconductor layer 67 and the channel layer 66 are etched to form a first opening 611 located on the channel layer 66. After that, a protective layer 69 is formed on the source/drain layer 68 and the gate insulating layer 65, and then the protective layer 69 is etched to form a contact hole 612 located on the source/drain layer 68 and a second opening 613 located on the contact pad 64. Finally, a transparent pixel electrode region 610 is formed on the contact hole 612, the protective layer 69 corresponding to the storage capacitor 63 and the second opening 613.

The gate insulating layer 65 is made of an insulating material selected from a group consisting of SiOx, SiNx, SiOxNy, TaOx, AlOx and mixture thereof. As for the source/drain layer 68, it is made of the metal with a low resistance, such as Mo, Al, AlNd alloy, Cr or mixture thereof.

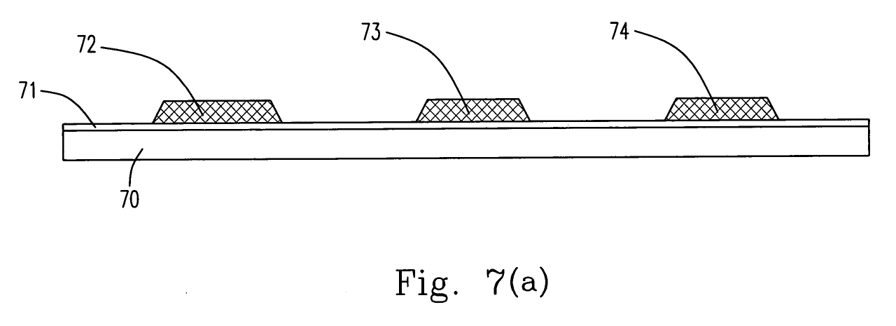

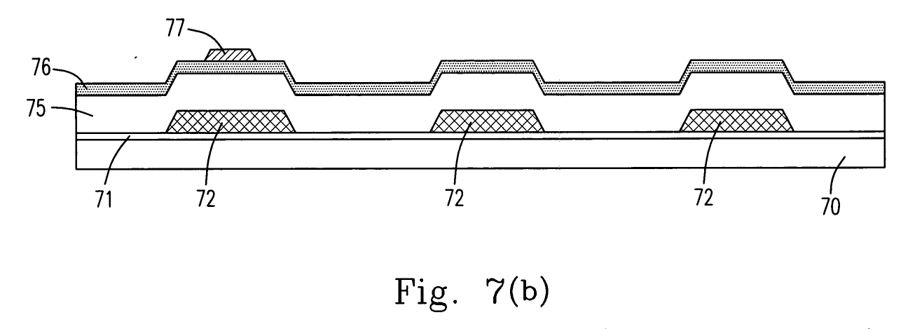

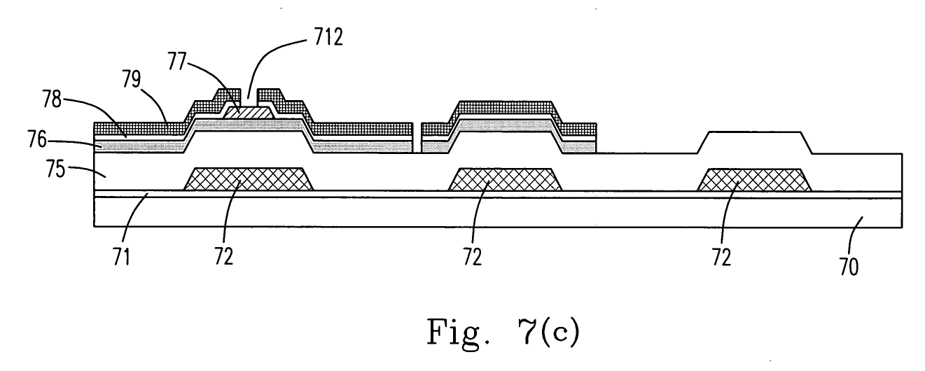

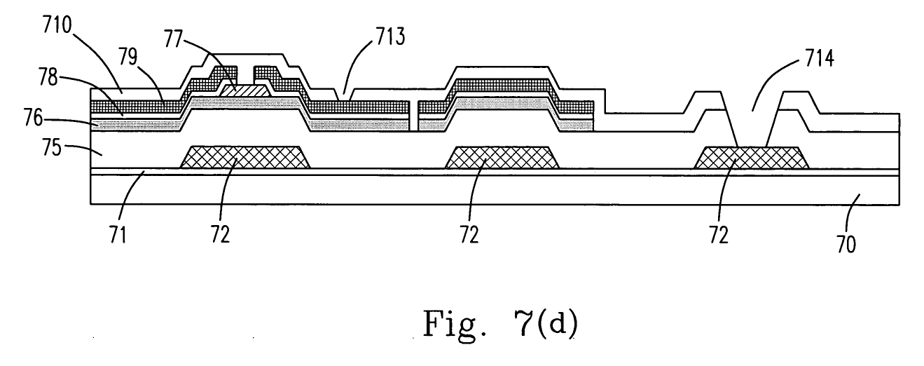

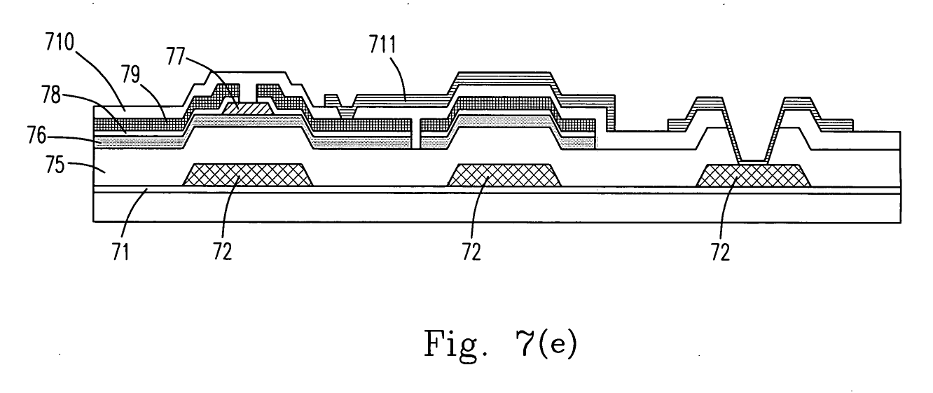

Please refer to FIGS. 7(a)˜7(e), which show the process for manufacturing the etching stopper thin film transistor according to a preferred embodiment of the present invention. At first, a dielectric layer 71 is formed on an upper surface of the glass substrate 70 by employing the above manufacturing process for reducing the glass sag. Then, a gate structure 72, a storage capacitor 73 and a contact pad 74 is formed on the glass substrate 70, and then a gate insulating layer 75 and a channel layer 76 are sequentially formed on the gate structure 72, the storage capacitor 73 and the contact pad 74. Afterwards, an etching stopper structure 77 is formed on the channel layer 76 corresponding to the gate structure 72, and then a semiconductor layer 78 and a source/drain layer 79 are sequentially formed on the etching stopper structure 77 and the channel layer 76. Next, the semiconductor layer 78 and the source/drain layer 79 are etched to form a first opening 712 located on the etching stopper structure 77, and then the channel layer 76, the semiconductor layer 78 and the source/drain layer 78 which are corresponding to the contact pad 74 are removed. After that, a protective layer 710 is formed on the source/drain layer 79 and the gate insulating layer 75, and then the protective layer 710 is etched to form a contact hole 713 located on the source/drain layer 79 and a second opening 714 located on the contact pad 74. Finally, a transparent pixel electrode region 710 is formed on the contact hole 713, the protective layer 710 corresponding to the storage capacitor 73 and the second opening 714.

The gate insulating layer 75 is made of an insulating material selected from a group consisting of the SiNx, SiNx, SiOxNy, TaOx, AlOx and mixture thereof. As for the source/drain layer 79, it is made of the metal with a low resistance, such as the Mo, Al, AlNd alloy, Cr and mixture thereof.

In conclusion, the present invention can reduce the glass sag by depositing a dielectric layer on the upper surface or the lower surface of the glass substrate and by adjusting the stress applied thereon. This technology can be integrated not only into the manufacturing process for glass substrates but into that for thin film transistors. Accordingly, the present invention can effectively solve the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for manufacturing a glass substrate, comprising steps of:
(a) providing a liquid glass matrix;
(b) solidifying said liquid glass matrix to form a glass matrix;
(c) dividing said glass matrix into a plurality of glass units;
(d) polishing each said glass unit;
(e) cutting a plurality of angled portions of each said glass unit;
(f) washing each said glass unit; and
(g) forming a dielectric layer on a surface of each said glass unit to form said glass substrate, wherein said dielectric layer is formed with a radio frequency ranged from 10 kHz to 100 MHz and a power density ranged from 0 to 1.4 Watts/cm², and applies a stress on each said glass unit.

2. The method as claimed in claim 1, wherein said dielectric layer is made of one selected from a group consisting of SiOx, SiNx, SiOxNy and mixture thereof.

3. The method as claimed in claim 1, wherein said dielectric layer has a thickness ranged from 500 Å to 5000 Å.

4. The method as claimed in claim 1, wherein said surface of each said glass unit is an upper surface thereof and said stress is a compressive stress.

5. The method as claimed in claim 4, wherein said compressive stress is ranged from −1×10⁹ dyne/cm² to −20×10⁹ dyne/cm².

6. The method as claimed in claim 1, wherein said surface of each said glass unit is a lower surface thereof and said stress is a tensile stress.

7. The method as claimed in claim 6, wherein said tensile stress is ranged from 1×10⁹ dyne/cm² to 20×10⁹ dyne/cm².

8. The method as claimed in claim 1, wherein said dielectric layer is formed under a pressure ranged from 0 to 10 Torr.

9. The method as claimed in claim 1, wherein said dielectric layer is formed at a temperature ranged from 25° C. to 400° C.

10. The method as claimed in claim 1, wherein said glass substrate has sag controlled between 0 to 14 mm.

11. A method for manufacturing a liquid crystal display, comprising steps of:
(a) providing a glass unit;
(b) forming a dielectric layer on a surface of said glass unit to form a glass substrate, wherein said dielectric layer is formed with a radio frequency ranged from 10 kHz to 100 MHz and a power density ranged from 0 to 1.4 Watts/cm², and applies a stress on said glass unit; and
(c) forming a thin film transistor structure on said dielectric layer.

12. The method as claimed in claim 11, wherein said dielectric layer is made of one selected from a group consisting of SiOx, SiNx, SiOxNy and mixture thereof.

13. The method as claimed in claim 11, wherein said dielectric layer has a thickness ranged from 500 Å to 5000 Å.

14. The method as claimed in claim 11, wherein said surface of each said glass unit is an upper surface thereof and said stress is a compressive stress.

15. The method as claimed in claim 14, wherein said compressive stress is ranged from −1×10⁹ dyne/cm² to −20×10⁹ dyne/cm².

16. The method as claimed in claim 11, wherein said surface of each said glass unit is a lower surface thereof and said stress is a tensile stress.

17. The method as claimed in claim 16, wherein said tensile stress is ranged from 1×10⁹ dyne/cm² to 20×10⁹ dyne/cm².

18. The method as claimed in claim 11, wherein said dielectric layer is formed under a pressure ranged from 0 to 10 Torr.

19. The method as claimed in claim 11, wherein said dielectric layer is formed at a temperature ranged from 25° C. to 400° C.

20. The method as claimed in claim 11, wherein said glass substrate has sag controlled between 0 to 14 mm.

21. The method as claimed in claim 11, wherein said thin film transistor structure is a back channel etched thin film transistor.

22. The method as claimed in claim 21, wherein said back channel etched thin film transistor is formed by steps of:
(a′) forming a gate structure, a storage capacitor and a contact pad on said glass substrate;
(b′) forming a gate insulating layer on said gate structure, said storage capacitor and said contact pad;
(c′) sequentially forming a channel layer and a semiconductor layer on said gate insulating layer corresponding to said gate structure;
(d′) forming a source/drain layer on said semiconductor layer;
(e′) etching said source/drain layer, said semiconductor layer and said channel layer to form a first opening located on said channel layer;
(f′) forming a protective layer on said source/drain layer and said gate insulating layer, and etching said protective layer to form a contact hole located on said source/drain layer and a second opening located on said contact hole; and
(g′) forming a transparent pixel electrode region on said contact hole, said protective layer corresponding to said storage capacitor and said second opening.

23. The method as claimed in claim 11, wherein said thin film transistor structure is an etching stopper thin film transistor structure.

24. The method as claimed in claim 23, wherein said etching stopper thin film transistor structure is formed by steps of:
(a″) forming a gate structure, a storage capacitor and a contact pad on said glass substrate;
(b″) sequentially forming a gate insulating layer and a channel layer on said gate structure, said storage capacitor and said contact pad;
(c″) forming an etching stopper structure on said channel layer corresponding to said gate structure;
(d″) sequentially forming a semiconductor layer and a source/drain layer on said etching stopper structure and said channel layer, and etching said semiconductor layer and said source/drain layer to form a first opening located on said etching stopper structure;
(e″) removing said channel layer, said semiconductor layer and said source/drain layer which are corresponding to said contact pad;
(f″) forming a protective layer on said source/drain layer and said gate insulating layer, and etching said protective layer to form a contact hole located on said source/drain layer and a second opening located on said contact pad; and
(g″) forming a transparent pixel electrode region on said contact hole, said protective layer corresponding to said storage capacitor and said second opening.
